(19) United States
(12) Patent Application Publication
(10) Pub. No.: US 2019/0239163 A1
(43) Pub. Date: Aug. 1, 2019

(54) LOW-POWER-CONSUMPTION COMMUNICATION METHOD AND DEVICE BASED ON MICRO-ENERGY COLLECTION NETWORK

(71) Applicant: SHENZHEN COOPERATION TECHNOLOGY CO., LTD., Shenzhen, Guangdong (CN)

(72) Inventor: Jianwu Hua, Shenzhen, Guangdong (CN)

(21) Appl. No.: 16/330,938

(22) PCT Filed: Dec. 20, 2016
(86) PCT No.: PCT/CN2016/111065

§ 371 Date: Mar. 6, 2019

(51) Int. Cl. H04W 52/02

(52) U.S. Cl. CPC H04W 52/0219

(57) ABSTRACT

A low-power-consumption communication method and device, and a micro-energy supply device, this method includes: presetting a timestamp or a preset channel; performing data interaction with the server by the micro-energy collection terminals according to respective timestamps or channels; and performing, by the various micro-energy collection terminal, update configuration of the micro-energy collection terminals according to acquired update data. The micro-energy collection terminals are enabled to perform data interaction with the server at regular time respectively according to their respective timestamps, and are kept in a dormant state to reduce power consumption greatly when the data interaction is not performed, so that these micro-energy collection terminals are completely applicable to power supply constraint of micro-energy collection, an overall management of multiple micro-energy collection terminals is achieved, and an application of the micro-energy collection network is greatly expanded.

### TECHNICAL FIELD

The present disclosure relates to the field of electronics, and more particularly to a low-power-consumption communication method based on micro-energy collection network, a low-power-consumption communication device based on micro-energy collection network, and a micro-energy supply device.

### BACKGROUND

Currently, new clean energy, especially the various micro-energy such as indoor light, object pressure deformation, water ripple kinetic energy and so on, which is represented by solar energy, wind energy and fluid energy, has attracted more and more attention due to zero pollution and sustainable development, if the new clean energy can be continuously collected and stored, power may be supplied for a plurality of low-power-consumption devices, and a load is self-powered without replacing power supply or being charged may be implemented. Moreover, a plurality of energy collection points may be arranged in one district, an energy acquisition network is constituted, and an intelligent management is achieved by the control of overall collection network.

Of course, it is inevitable to perform data interaction through communication in the management of collection network, however, the existing communication method has very high power consumption, speaking of the fact that the micro-energy acquisition terminal may only collect current of micro-ampere level for each time, the power consumption of the existing communication method is severely unaffordable, so that the application of the micro-energy collection network is restrained, and a rapid development of the energy revolution is hindered.

### SUMMARY

An object of the present disclosure is to provide a low-power-consumption communication method based on micro-energy collection network, which aims at solving a problem that the existing communication method has very high power consumption and thus is unsuitable for data communication of micro-energy collection network.

The embodiments of the present disclosure are implemented in this way: a low-power-consumption communication method based on a micro-energy collection network which includes micro-energy collection terminals and a server, and the method includes:

presetting a timestamp or a preset channel in each micro-energy collection terminal;

performing data interaction with the server by the micro-energy collection terminals according to their respective timestamps or channels, where the timestamp or the channel is preset or updated, the data interaction includes uploading collection data onto the server by the micro-energy collection terminal, identifying an update instruction by the micro-energy collection terminal, and transmitting an update request to the server by the micro-energy collection terminal; and

updating, by the micro-energy collection terminals, configurations of the micro-energy collection terminals according to update data acquired from the server.

Another object of the embodiments of the present disclosure is to provide a low-power-consumption communication device based on a micro-energy collection network, the micro-energy collection network is configured to be arranged in each micro-energy collection terminal in the micro-energy collection network, the communication device includes:

a communication control unit configured to perform data interaction with a server according to a timestamp or a channel, where the timestamp or the channel is preset or updated, the data interaction includes uploading collection data onto the server by the micro-energy collection terminal, identifying an update instruction by the micro-energy collection terminal, and transmitting an update request to the server by the micro-energy collection terminal; and

a configuration update unit configured to update configuration according to update data acquired from the server, where the update data includes a collection mode, terminal location information and the timestamp.

Another object of the embodiments of the present disclosure is to provide a micro-energy supply device including the aforesaid low-power-consumption communication device based on micro-energy collection network.

According to the embodiment of the present disclosure, the micro-energy collection terminals respectively perform data interaction with the server at regular time according to their respective timestamps, and are kept in the dormant state to reduce the power consumption greatly when the data interaction is not performed, these micro-energy collection terminals are completely applicable to power supply constraint of micro-energy collection, an overall management of multiple micro-energy collection terminals is achieved, an application of the micro-energy collection network is greatly expanded, and a rapid development of energy revolution is promoted.

### BRIEF DESCRIPTION OF THE DRAWINGS

FIG. 1 illustrates a flowchart structural diagram of a low-power-consumption communication method based on micro-energy collection network provided by an embodiment of the present disclosure;

FIG. 2 illustrates a flowchart structural diagram of step 102 in the low-power-consumption communication method based on micro-energy collection network provided by the embodiment of the present disclosure;

FIG. 3 illustrates a flowchart structural diagram of step 201 in the low-power-consumption communication method based on micro-energy collection network provided by the embodiment of the present disclosure;

FIG. 4 illustrates a flowchart structural diagram of step 302 in the low-power-consumption communication method based on micro-energy collection network provided by the embodiment of the present disclosure;

FIG. 5 illustrates a low-power-consumption communication device based on micro-energy collection network provided by an embodiment of the present disclosure; and

FIG. 6 illustrates a structural diagram of a communication control unit in the low-power-consumption communication device based on micro-energy collection network provided by the embodiment of the present disclosure.

### DESCRIPTION OF THIS EMBODIMENTS

In order to make the purpose, the technical solutions and the advantages of the present disclosure be clearer and more understandable, the present disclosure is further described in detail below with reference to accompanying figures and embodiments. It should be understood that the specific embodiments described herein are only intended to illustrate but not to limit the present disclosure. In addition, the technical features involved in the various embodiments of the present disclosure below may be combined as long as they don't conflict with each other.

According to the embodiment of the present disclosure, the micro-energy collection terminals respectively perform data interaction with a server at regular time according to their respective timestamps, and are kept in dormant state to reduce power consumption greatly when data interaction is not performed, these micro-energy collection terminals are completely applicable to power supply constraint of micro-energy collection, an overall management of multiple micro-energy collection terminals is achieved, and an application of the micro-energy collection network is expanded.

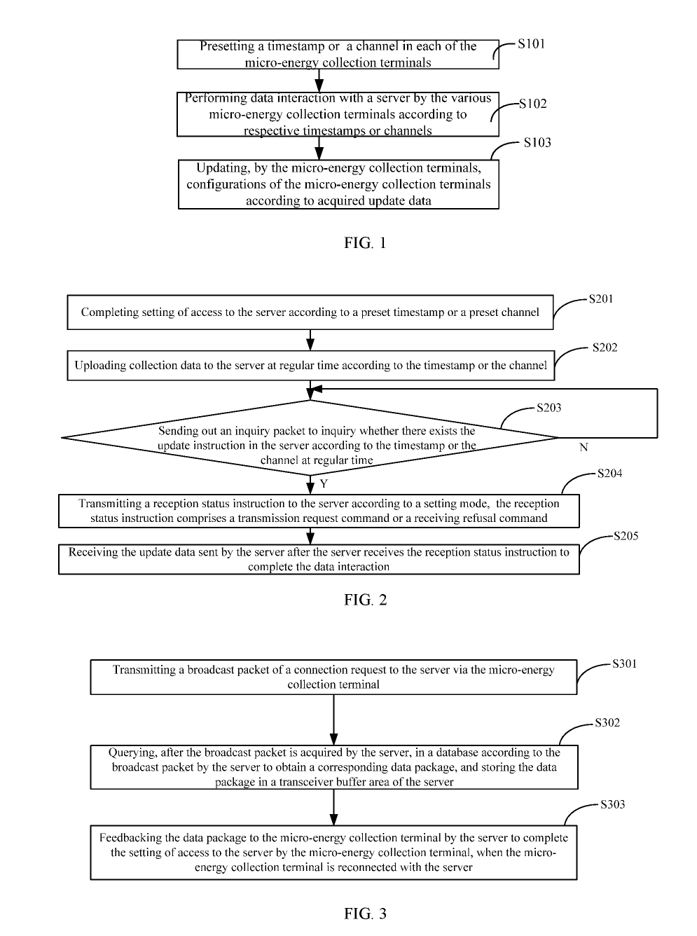

FIG. 1 illustrates a flowchart structure diagram of a low-power-consumption communication method based on a micro-energy collection network according to an embodiment of the present disclosure, for the convenience of description, the part related to the present disclosure is illustrated merely.

As an embodiment of the present disclosure, the low-power-consumption communication method based on the micro-energy collection network may be applied to communication of collection network of light energy, wind energy, fluid energy and pressure kinetic energy, and is especially suitable for application fields such as security and protection monitoring, industrial automatic control, field environment observation, animal and plant growth state observation, and so on.

As an embodiment of the present disclosure, the micro-energy collection network includes micro-energy collection terminals and a server, and the low-power-consumption communication method based on the micro-energy collection network includes steps as follows:

In step 101, presetting a timestamp or a channel in the micro-energy collection terminals;

In the embodiment of the present disclosure, due to the fact that larger power consumption is resulted when a communication system of the micro-energy collection terminal is started once, for this reason, the micro-energy collection terminal may be enabled to enter a dormant state firstly, and is woken up at regular time according to the timestamp.

During a first communication, a communication is performed with the server through default timestamps or default channels preset in the micro-energy collection terminals; for example, a preset timestamp in a first micro-energy collection terminal is 12:00, a preset timestamp in a second micro-energy collection terminal is 12:05, a preset timestamp in a third micro-energy collection terminal is 12:10 . . . these micro-energy collection terminals communicate with the server sequentially when their respective timestamps arrive; besides, after an updated timestamp in the update data of the server is acquired, the next communication is performed according to the updated timestamp.

In addition, information including a channel, a frequency hopping mode may be carried in the timestamp, it is possible to skip to another channel by frequency hopping to perform communication when interference is received in the current channel; or as an alternative, the server simultaneously communicates with a plurality of micro-energy collection terminals via multiple channels simultaneously when there are too many terminals currently.

In the embodiment of the present disclosure, the timestamps of the micro-energy collection terminals may be set as different, these micro-energy collection terminals may relieve communication congestion in a manner of communicating with the server in sequence; the timestamps of the micro-energy collection terminals may also be set as partially the same or completely the same, the communication efficiency is improved by simultaneously communicating with the multiple micro-energy collection terminals via different channels, and the communication congestion is relieved.

Particularly, the timestamp may include a temporary timestamp and a system timestamp;

The temporary timestamp is allocated when a temporary access is needed, and is invalidated after one-time communication is completed;

The system timestamp is distributed after being authenticated by the server, when the timestamp time of the system arrives, communication of the temporary timestamp is interrupted.

As an embodiment of the present disclosure, the temporary timestamp and the system timestamp may be located in different channels;

the micro-energy collection terminal is configured to automatically skip to the next channel to perform communication again through frequency hopping when there is no response in the current timestamp;

The frequency hopping channel and the frequency hopping mode may be sent to the micro-energy collection terminal by the server, and may also be acquired by the micro-energy collection terminal.

In step 102, performing data connection with the server sequentially by the micro-energy collection terminals according to respective timestamps or channels, the timestamps or the channels are preset or updated, the data interaction includes uploading collection data onto the server by the micro-energy collection terminal, identifying an update instruction by the micro-energy collection terminal, and transmitting an update request to the server by the micro-energy collection terminal.

In this embodiment of the present disclosure, when the micro-energy collection terminal does not establish communication with the server, the micro-energy collection terminal is woken up by a default timestamp preset in the micro-energy collection terminal at regular time to try to communicate with the server, and use the updated timestamp to communicate with the server again after obtaining the updated timestamp from the server.

Particularly, a timeslice is set to enable the multiple micro-energy collection terminals to communicate with the server according to the timestamps in the timeslice in step 102.

In the embodiment of the present disclosure, the preset timestamps of the micro-energy collection terminals may be the same or be different, and the channels preset in the micro-energy collection terminals may also be the same or different.

When the server is idle, the data interaction is smooth, and the probability that the micro-energy collection terminals compete for channel resources with each other is relatively low, so that the data communication may be guaranteed through interaction of low-frequency timestamps; however, when the server is busy, due to the fact that the micro-energy collection terminals compete for channel resources more frequently, a communication mode with a high frequency timestamp needs to be adopted, thereby obtaining more competitive advantages and guaranteeing that the micro-energy collection terminal interacts with the server smoothly.

Preferably, the collection data includes a current collection mode, a current collection electric quantity and a total collection electric quantity.

As a preferable embodiment of the present disclosure, before the micro-energy collection terminal performs data interaction with the server, the server may be instructed to store update data and update instructions in a buffer unit after the data is updated, where the update data includes a collection mode, location information of the micro-energy collection terminal and a timestamp.

In the embodiment of the present disclosure, a network structure needs to be adjusted due to user requirements including the increase of the number of the micro-energy collection terminals, and the movement of the micro-energy collection terminal's location, and the server performs data update according to the adjustment of the network structure, and preloads the data that needs to be communicated in the next time into the buffer area, thereby shortening an interaction time between the micro-energy collection terminal and the server, and reducing the energy consumption required for communication.

The update time of the server may be determined according to the timestamp. The update instruction and the update data of the buffer area are replaced and stored when data update is performed by the server.

As a preferable embodiment of the present disclosure, the server may also analyze and manage the collection data uploaded by the micro-energy collection terminals, and perform the data update according to an analysis result, and generate the update data.

As a preferable embodiment of the present disclosure, when the micro-energy collection terminal performs data interaction with the server, the server is configured to record breakpoint data in order that the data interaction be continued to be performed according to the breakpoint data when the data interaction is performed again, if the data interaction is not completed within a preset timestamp or preset channel time.

In step 103, updating configurations of the micro-energy collection terminals by the micro-energy collection terminals according to acquired update data.

As a preferred embodiment of the present disclosure, the micro-energy collection network may further include a user terminal;

The user terminal is configured to acquire collection data and analysis results uploaded by the micro-energy collection terminals from the server; or

as an alternative, the user terminal is configured to acquire the collection data uploaded by the micro-energy collection terminals from the server, analyze and manage the collection data uploaded by the micro-energy collection terminals, perform data update according to the analysis result to generate the update data, and upload the update data to the server.

According to the embodiment of the present disclosure, the micro-energy collection terminals respectively perform data interaction with the server at regular time according to their respective timestamps, and are kept in the dormant state to reduce the power consumption greatly when the data interaction is not performed, these micro-energy collection terminals are completely applicable to power supply constraint of micro-energy collection, an overall management of multiple micro-energy collection terminals is achieved, an application of the micro-energy collection network is greatly expanded, and a rapid development of energy revolution is promoted.

FIG. 2 illustrates a flowchart structure diagram of a step 102 in the low-power-consumption communication method based on micro-energy collection network according to an embodiment of the present disclosure, for the convenience of description, the part related to the present disclosure is illustrated merely.

As an embodiment of the present disclosure, the step 102 particularly includes the steps as follows:

In step 201, completing, by the micro-energy collection terminal, a setting of access to the server according to a preset timestamp or a preset channel;

In step 202, uploading, by the micro-energy collection terminal, collection data to the server according to the timestamp or the channel at regular time;

In step 203, transmitting, by the micro-energy collection terminal, an inquiry packet to inquire whether there exists an update instruction in the server or not at regular time according to the time stamp or the channel;

waiting for inquiry again if there doesn't exist the update instruction in the server, returning back to the step 203; and

executing step 204 if there exists the update instruction in the server, transmitting, by the micro-energy collection terminal, a receiving state instruction to the server according to a setting mode, where the receiving state instruction includes a transmission request instruction or a receiving refusal instruction;

Particularly, the setting mode includes idle time and busy time;

the micro-energy collection terminal is configured to transmit the reception status instruction to the server at a preset low-frequency timestamp when it is idle;

the micro-energy collection terminal is further configured to transmit the reception status instruction to the server at a preset high-frequency timestamp when it is busy.

In step 205, receiving, after the reception status instruction is received by the server, the update data sent by the server by the micro-energy collection terminal to complete the data interaction.

FIG. 3 illustrates a flowchart structure diagram of step 201 in the low-power-consumption communication method based on micro-energy collection network according to the embodiment of the present disclosure, for the convenience of description, the part related to the present disclosure is illustrated merely.

As an embodiment of the present disclosure, step 201 particularly includes the steps as follows:

In step 301, transmitting, by the micro-energy collection terminal, a broadcast packet of a connection request to the server, where the broadcast packet includes a local address, a device type and a timestamp;

In step 302, querying, after the broadcast packet is obtained by the server, in a database by the server according to the broadcast packet to obtain the corresponding data package, and storing the data package in a transceiving buffer area of the server;

In step 303, feedbacking, when the micro-energy collection terminal is connected with the server again, the data package to the micro-energy collection terminal by the server to complete setting of access to the server by the micro-energy collection terminal.

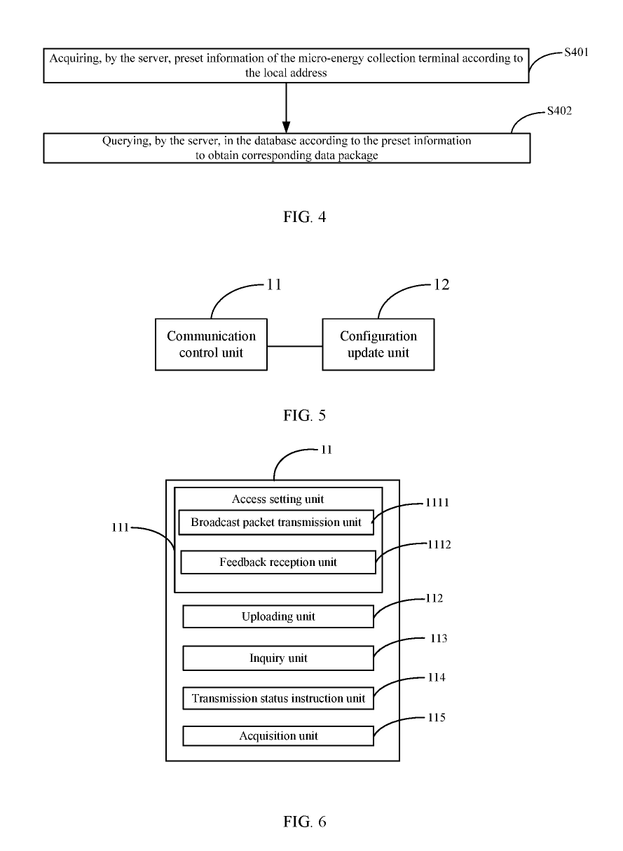

FIG. 4 illustrates a flowchart structure diagram of step 302 in the low-power-consumption communication method based on micro-energy collection network according to the embodiment of the present disclosure, for the convenience of description, the part related to the present disclosure is illustrated merely.

As an embodiment of the present disclosure, the step 302 particularly includes the steps as follows:

In step 401, acquiring, by the server, preset information of the micro-energy collection terminal according to the local address, where the preset information includes a device type, an installation location and a communication mode of the micro-energy collection terminal;

In step 402, querying, by the server, in the database according to the preset information to obtain a corresponding data package, where the data package includes a communication ID, a communication packet length and a timestamp of the micro-energy collection terminal.

According to the embodiment of the present disclosure, the micro-energy collection terminals respectively perform data interaction with the server at regular time according to respective timestamps, and are kept in the dormant state to reduce the power consumption greatly when the data interaction is not performed, these micro-energy collection terminals are completely applicable to power supply constraint of micro-energy collection, an overall management of multiple micro-energy collection terminals is achieved, an application of the micro-energy collection network is greatly expanded, and a rapid development of energy revolution is promoted.

FIG. 5 illustrates a structural diagram of a low-power-consumption communication device based on micro-energy collection network provided by an embodiment of the present disclosure, for the convenience of description, the part related to the present disclosure is illustrated merely.

As an embodiment of the present disclosure, the low-power-consumption communication device based on micro-energy collection network is arranged in each of the micro-energy collection terminals in the micro-energy collection network and includes:

a communication control unit 11 configured to perform data interaction with a server according to a timestamp or a channel, where the timestamp or the channel is preset or updated, the data interaction includes uploading collection data onto the server by the micro-energy collection terminal, identifying an update instruction by the micro-energy collection terminal, transmitting an update request to the server by the micro-energy collection terminal; and

a configuration update unit 12 configured to update configuration according to update data acquired from the server, wherein the update data includes a collection mode, terminal location information and the timestamp.

As a preferable embodiment of the present disclosure, the collection data includes a current collection mode, a current collection electric quantity and a total collection electric quantity.

Preferably, before the micro-energy collection terminal performs data interaction with the server, the server may be instructed to store update data and update instructions in a buffer unit after the data is updated.

In the embodiment of the present disclosure, a network structure needs to be adjusted due to user requirements including the increase of the number of the micro-energy collection terminals, and the movement of location of the micro-energy collection terminal, and the server performs data update according to the adjustment of the network structure, and preloads the data that needs to be communicated in the next time into the buffer area, thereby shortening an interaction time between the micro-energy collection terminal and the server, and reducing the energy consumption required for communication.

The update time of the server may be determined according to the timestamp. The update instruction and the update data of the buffer area are replaced and stored when data update is performed by the server. The server may also be configured to analyze and manage the collection data uploaded by the micro-energy collection terminals, and perform data update according to an analysis result to generate update data.

In the embodiment of the present disclosure, since larger power consumption is resulted when a communication system of the micro-energy collection terminal is started once, for this reason, the micro-energy collection terminal may be enabled to enter a dormant state firstly, and is woken up at regular time according to the timestamp.

During a first communication, a communication is performed with the server through default timestamps or default channels preset in the micro-energy collection terminals; for example, a preset timestamp in a first micro-energy collection terminal is 12:00, a preset timestamp in a second micro-energy collection terminal is 12:05, a preset timestamp in a third micro-energy collection terminal is 12:10 . . . these micro-energy collection terminals communicate with the server sequentially when their respective timestamps arrive; besides, after an updated timestamp in the update data of the server is acquired, the next communication is performed according to the updated timestamp.

In this embodiment of the present disclosure, when the micro-energy collection terminal does not establish communication with the server, the micro-energy collection terminal is woken up by a default timestamp preset in the micro-energy collection terminal at regular time to try to communicate with the server, and use updated timestamp to communicate with the server again after the updated timestamp from the server is obtained.

In addition, information including a channel, a frequency hopping mode may be carried in the timestamp, it is possible to skip to another channel through frequency hopping to perform communication when interference is received in the current channel; or as an alternative, the server simultaneously communicates with multiple micro-energy collection terminals through multiple channels simultaneously when there are too many terminals currently.

In the embodiment of the present disclosure, the timestamps of the micro-energy collection terminals may be set as different, these micro-energy collection terminals may relieve communication congestion in a manner of communicating with the server in sequence; the timestamps of the micro-energy collection terminals may also be set as partially the same or completely the same, the communication efficiency is improved by simultaneously communicating with the multiple micro-energy collection terminals via different channels, and the communication congestion is relieved.

Particularly, the timestamp may include a temporary timestamp and a system timestamp;

The temporary timestamp is allocated when a temporary access is needed, and is invalidated after one-time communication is completed;

The system timestamp is distributed after being authenticated by the server, when the timestamp time of the system arrives, communication of the temporary timestamp is interrupted.

Further, the temporary timestamp and the system timestamp may be in different channels;

The communication control unit 11 is configured to automatically skip to the next channel through frequency hopping to perform communication again when there is no response in the current timestamp, the frequency hopping channel and the frequency hopping mode are sent by the server.

In the embodiment of the present disclosure, the preset timestamps of the micro-energy collection terminals may be the same or be different, and the channels preset in the micro-energy collection terminals may also be the same or different.

When the server is idle, the data interaction is smooth, and the probability that the micro-energy collection terminals compete for channel resources with each other is relatively low, so that the data communication may be guaranteed through interaction of low-frequency timestamps; however, when the server is busy, due to the fact that the micro-energy collection terminals compete for channel resources more frequently, a communication mode with a high frequency timestamp needs to be adopted to obtain more competitive advantages and guarantee that the micro-energy collection terminal interacts with the server smoothly.

As a preferable embodiment of the present disclosure, when the micro-energy collection terminal performs data interaction with the server, the server is configured to record breakpoint data in order that the data interaction be continued to be performed according to the breakpoint data when the data interaction is performed again, if the data interaction is not completed within a preset timestamp or preset channel time.

As a preferable embodiment of the present disclosure, the low-power-consumption communication device based on micro-energy collection network may also be connected with a user terminal through the server.

The user terminal is configured to acquire the collection data uploaded by the low-power-consumption communication device based on micro-energy collection network in the micro-energy collection terminals from the server, analyze and manage the collection data uploaded by the micro-energy collection terminals, perform data update according to the analysis result to generate the update data, and upload the update data to the server.

According to the embodiment of the present disclosure, the micro-energy collection terminals respectively perform data interaction with the server at regular time according to their respective timestamps, and are kept in the dormant state to reduce the power consumption greatly when the data interaction is not performed, these micro-energy collection terminals are completely applicable to power supply constraint of micro-energy collection, an overall management of multiple micro-energy collection terminals is achieved, an application of the micro-energy collection network is greatly expanded, and a rapid development of energy revolution is promoted.

FIG. 6 illustrates a structure of a communication control unit 11 in the low-power-consumption communication device based on micro-energy collection network provided by the embodiment of the present disclosure, for the convenience of description, the part related to the present disclosure is illustrated merely.

As an embodiment of the present disclosure, the communication control unit 11 includes:

an access setting unit 111 configured to complete setting of access with the server according to a preset timestamp or a preset channel;

an uploading unit 112 configured to upload collection data to the server at regular time according to the timestamp or the channel;

an inquiry unit 113 configured to send out an inquiry packet according to the timestamp or the channel at regular time to inquiry whether there exists the update instruction in the server, and to wait for inquiry again if there doesn't exist the update instruction in the server; and

a transmission status instruction unit 114 configured to transmit a reception status instruction to the server according to a setting mode if there exists the update instruction in the server, where the reception status instruction includes a transmission request command or a receiving refusal command.

Particularly, the setting mode may include idle time and busy time;

the transmission status instruction unit 114 is further configured to transmit a reception status instruction to the server at a preset low-frequency timestamp when it is idle;

the transmission status instruction unit 114 is further configured to transmit a reception status instruction to the server at a preset high-frequency timestamp when it is busy.

The communication control unit 11 further includes an acquisition unit 115 configured to receive the update data sent by the server to complete the data interaction after the reception status instruction is received by the server.

Preferably, the communication control unit 11 further includes a timeslice arranging unit 116 configured to arrange a timeslice to enable communication control units in micro-energy collection terminals to perform data interaction with the server respectively according to the timestamp in the timeslice.

As a preferable embodiment of the present disclosure, the access setting unit 111 includes:

a broadcast packet transmission unit 1111 configured to transmit a broadcast packet of a connection request to the server, where the broadcast packet includes a local address, a device type and a timestamp; and

a feedback reception unit 1112 configured to receive the data package as feedback from the server to complete the setting of access when it is reconnected with the server, where the data package is acquired by the server by querying in the database according to the broadcast packet after the broadcast packet is acquired by the server, and is stored in a transceiving buffer area of the server.

Another object of the embodiments of the present disclosure is to provide a micro-energy supply device including the aforesaid low-power-consumption communication device based on micro-energy collection network.

According to the embodiment of the present disclosure, the micro-energy collection terminals respectively perform data interaction with the server at regular time according to their respective timestamps, and are kept in the dormant state to reduce the power consumption greatly when the data interaction is not performed, these micro-energy collection terminals are completely applicable to power supply constraint of micro-energy collection, an overall management of multiple micro-energy collection terminals is achieved, an application of the micro-energy collection network is greatly expanded, and a rapid development of energy revolution is promoted.

The foregoing only describes preferable embodiments of the present disclosure and is not intended to limit the present disclosure. Any modification, equivalent replacement, improvement, and the like, which are made within the spirit and the principle of the present disclosure, should all be included in the protection scope of the present disclosure.

1. A low-power-consumption communication method based on a micro-energy collection network which comprises a plurality of micro-energy collection terminals and a server, wherein the method comprises:
presetting a timestamp or a channel in each of the micro-energy collection terminals;
performing data interaction with the server by the micro-energy collection terminals according to respective timestamps or channels, wherein the timestamp or the channel is preset or updated, the data interaction comprises uploading collection data onto the server by the micro-energy collection terminal, identifying an update instruction by the micro-energy collection terminal, and transmitting an update request to the server by the micro-energy collection terminal; and
updating, by the each of the micro-energy collection terminals, configurations according to update data acquired from the server.

2. The method according to claim 1, wherein the collection data comprises a current collection mode, a current collection electric amount and a total collection electric amount.

3. The method according to claim 1, further comprising: storing, after the data is updated, the update data and the update instruction in a buffer unit by the server, wherein the update data comprises a collection mode, terminal location information and a timestamp, and the update instruction and the update data in the buffer unit are replaced and stored when data update is performed by the server.

4. The method according to claim 1, wherein the timestamp comprises a temporary timestamp and a system timestamp, wherein:
the temporary timestamp is allocated when a temporary access is needed, and is invalidated after one-time communication is completed; and
the system timestamp is allocated after the system timestamp is authenticated by the server, wherein communication with the temporary timestamp is interrupted when time of the system timestamp arrives.

5. The method according to claim 4, wherein the temporary timestamp and the system timestamp are in different channels, and the method further comprises:
automatically frequency hopping to a next channel to retry the communication when there is no response from the micro-energy collection terminal within current timestamp.

6. The method according to claim 1, wherein the step of performing data interaction with the server by the micro-energy collection terminals according to respective timestamps or channels comprises:
arranging a timeslice, wherein the data interaction in the timeslice between the plurality of micro-energy collection terminals and the server is performed according to the timestamp.

7. The method according to claim 1, wherein the step of performing data interaction with the server by the micro-energy collection terminals according to the timestamp or the channel comprises:
completing setting of access to the server by the micro-energy collection terminal according to a preset timestamp or a preset channel;
uploading collection data to the server at regular time by the micro-energy collection terminal according to the timestamp or the channel;
sending out an inquiry packet according to the timestamp or the channel at regular time by the micro-energy collection terminal to inquiry whether there exists the update instruction in the server;
waiting for inquiry again if there doesn't exist the update instruction in the server;
transmitting, if there exists the update instruction in the server, a reception status instruction to the server by the micro-energy collection terminal according to a setting mode, wherein the reception status instruction comprises a transmission request command or a receiving refusal command; and
receiving, after the reception status instruction is received by the server, the update data sent from the server by the micro-energy collection terminal to complete the data interaction.

8. The method according to claim 7, wherein the step of completing setting of access to the server by the micro-energy collection terminal according to a preset timestamp or a preset channel comprises:
transmitting a broadcast packet of a connection request to the server by the micro-energy collection terminal, wherein the broadcast packet comprises a local address, a device type and a timestamp;
querying, after the broadcast packet is acquired by the server, in a database by the server according to the broadcast packet to obtain a corresponding data package, and storing the data package in a transceiving buffer area of the server; and
feedbacking, when the micro-energy collection terminal is reconnected with the server, the data package to the micro-energy collection terminal by the server to complete the setting of access between the micro-energy collection terminal and the server.

9. The method according to claim 8, wherein the step of querying, after the broadcast packet is acquired by the server, in a database by the server according to the broadcast packet to obtain a corresponding data package comprises:
obtaining, by the server, preset information of the micro-energy collection terminal according to the local address, wherein the preset information comprises a device type, an installation location and a communication mode of the micro-energy collection terminal; and
querying, by the server, in the database according to the preset information to obtain corresponding data package, wherein the data package comprises a communication ID, a communication packet length and a timestamp of the micro-energy collection terminal.

10. The method according to claim 7, wherein the setting mode comprises idle time and busy time, wherein:
the micro-energy collection terminal is configured to transmit the reception status instruction to the server in the idle time at a preset low frequency timestamp;
the micro-energy collection terminal is configured to transmit the reception status instruction to the server in the busy time at a preset high frequency timestamp.

11. The method according to claim 1, further comprising:
recording, when the micro-energy collection terminal performs the data interaction with the server and if the data interaction is not completed within a preset timestamp or preset channel time, breakpoint data by the server in order that the data interaction is continued to be performed according to the breakpoint data when the data interaction is performed again.

12. The method according to claim 1, further comprising:
analyzing and managing the collection data uploaded from the micro-energy collection terminals by the server, and performing data update to generate update data according to an analysis result.

13. The method according to claim 12, wherein the micro-energy collection network further comprises a user terminal, and the method further comprises:
obtaining, by the user terminal, the collection data and the analysis result uploaded by the micro-energy collection terminals from the server; or
obtaining the collection data uploaded by the micro-energy collection terminals from the server, analyzing and managing the collection data uploaded by the micro-energy collection terminals, performing the data update according to the analysis result to generate the update data, and uploading the update data to the server by the user terminal.

14. A low-power-consumption communication device based on a micro-energy collection network, the low-power-consumption communication device being configured to be arranged in each micro-energy collection terminal in the micro-energy collection network and comprising:
a communication control unit configured to perform data interaction with a server according to a timestamp or a channel, wherein the timestamp or the channel is preset or updated, the data interaction comprises uploading collection data onto the server by the micro-energy collection terminal, identifying an update instruction by the micro-energy collection terminal, and transmitting an update request to the server by the micro-energy collection terminal; and
a configuration update unit configured to update configuration according to update data acquired from the server, wherein the update data comprises a collection mode, terminal location information and the timestamp.

15. The device according to claim 14, wherein the collection data comprises a current collection mode, a current collection electric quantity and a total collection electric quantity.

16. The device according to claim 14, wherein the timestamp comprises a temporary timestamp and a system timestamp, the temporary timestamp is allocated when a temporary access is needed and is invalidated after one-time communication is completed; and
the system timestamp is allocated after it is authenticated by the server, and communication of the temporary timestamp is interrupted when the system timestamp arrives.

17. The device according to claim 16, wherein the temporary timestamp and the system timestamp are in different channels, the communication control unit is configured to automatically skip to a next channel by frequency hopping to retry communication when there is no response in current timestamp.

18. The device according to claim 14, wherein the communication control unit comprises a timeslice arranging unit configured to arrange a timeslice to enable communication control units in a plurality of micro-energy collection terminals to perform data interaction with the server respectively according to the timestamp in the timeslice.

19. The device according to claim 14, wherein the communication control unit comprises:
an access setting unit configured to complete setting of access with the server according to a preset timestamp or a preset channel;
an uploading unit configured to upload the collection data to the server at regular time according to the timestamp or the channel;
an inquiry unit configured to send out an inquiry packet according to the timestamp or the channel at regular time to inquiry whether there exists the update instruction in the server, and to wait for inquiry again if there doesn't exist the update instruction in the server;
a transmission status instruction unit configured to transmit a reception status instruction to the server according to a setting mode if there exists the update instruction in the server, wherein the reception status instruction comprises a transmission request command or a receiving refusal command; and
an acquisition unit configured to receive the update data sent by the server to complete the data interaction after the reception status instruction is received by the server.

20-21. (canceled)

22. A micro-energy supply device, comprising the low-power-consumption communication device based on micro-energy collection network according to claim 14.
